(19) United States
(12) Patent Application Publication
(10) Pub. No.: US 2014/0358821 A1
(43) Pub. Date: Dec. 4, 2014

(54) Robust Method for Portfolio Management

(71) Applicant: Min Min, Shanghai (CN)

(72) Inventor: Min Min, Shanghai (CN)

(73) Assignee: Min Min, Shanghai (CN)

(21) Appl. No.: 13/903,862

(22) Filed: May 28, 2013

(51) Int. Cl. G06Q 40/00

(52) U.S. Cl. CPC G06Q 40/06
USPC 705/36 R

(57) ABSTRACT

A method for improve or reconstruct an existing or putative portfolio with different assets. Construct two kinds of “centroids” in order to reduce estimation-errors and uncertainties of the future. Then base on prior knowledge of risk region and uncertainty, one can construct their own weighted efficient frontier after their using the classic MV method and complete the next stage with a specified risk objective.

### TECHNICAL FIELD

The present invention relates to a method for portfolio robust optimal selection

### BACKGROUND OF THE INVENTION

The allocation of assets has always been a fairly important part of fund management, typically seek to maximize the expected or average return on an overall investment of funds for a given level of risk as defined in terms of variance of return, either historically or as adjusted using prior knowledge from analysts' expertise. Alternatively, the goal of a portfolio management strategy may be cast as the minimization of risk for a given level of expected return.

It is Markowitz who first constructed the above analytical framework for portfolio selection in 1952, namely the famous “mean-variance (MV) efficient frontier” using known techniques of linear or quadratic programming for optimization.in his theory, a portfolio may be optimized, with the goal of deriving the peak average return for a given level of risk and any specified set of constraints. With a limit of short, the objective part of his model can be expressed as another version, finding the minimum risk portfolio with a given expected return:

$$min V$$

$$s . t . \\ \begin{matrix}ER = {\sum }_{i = 1}^{n} {w}_{i} {r}_{i} \\ = {R}^{*}\end{matrix}$$

$$V = {\sum }_{i = 1}^{n} {w}_{i}^{2} {σ}_{i}^{2} + {\sum }_{j = 1}^{n} {\sum }_{{k = 1}_{k \neq j}}^{n} {w}_{j} {w}_{k} {σ}_{jk} ;$$

$${\sum }_{i = 1}^{n} {w}_{i} = 1 ;$$

$$∀ i , \\ {w}_{i} \geq 0$$

Where V and ER are the portfolio's expected return and variance, wᵢ, rᵢ and σᵢ² are the relative weight, expected return and variance of the i-th asset within the portfolio, and σⱼₖ is the covariance of the i-th and j-th assets. R* is the given expected return level.

However, known deficiencies of MV optimization as a practical tool for investment management include the instability and ambiguity of solutions. It is known that MV optimization may give rise to solutions which are both unstable with respect to small changes (within the uncertainties of the input parameters) and often non-intuitive and thus of little investment sense or value for investment purposes and with poor out-of-sample average performance. These deficiencies are known to arise due to the propensity of MV optimization as “estimation-error maximizers,” as discussed in R. Michaud, “The Markowitz Optimization Enigma: Is Optimized Optimal?” Financial Analysts Journal (1989), which is herein incorporated by reference. In particular, MV optimization tends to overweight those assets having large statistical estimation errors associated with large estimated returns, small variances, and negative correlations, often resulting in poor ex-post performance.

Mean-Variance Efficient Portfolio is calculated from the sample mean and covariance, which are likely different from the population mean and covariance. To account for the uncertainty of the sample estimates, Resampled Efficiency™ (U.S. Pat. No. 6,003,018) is invented. In this method a financial analyst can create many alternative efficient frontiers based on resampled versions of the data. Each resampled dataset will result in a different set of Markowitz efficient portfolios. These efficient frontiers of portfolios can then averaged to create a resampled efficient frontier. Based on that, the appropriate compromise between the investor's Risk aversion and desired return will then guide the financial analyst to choose a portfolio from the set of resampled efficient frontier portfolios, just like Markowitz's method does.

The advantage of Resampled Efficiency™ is its use of available data to produce more intuitive portfolio allocations which are less sensitive. Also, because Resampled Efficiency™ is an averaging process, it is very stable. Small changes in the inputs are generally associated with only small changes in the optimized portfolios. The resampling process therefore provides protection against over fitting of data. So it performs well whatever in a use or a test.

But this method has several problems. First, the resampling process requires high computing capacity and good performance of random generator, otherwise it brings a bad result. Still, the final results are correlated to the mentioned factors plus the times of resampling. Second, the new frontier is “shorter” than MV's, and one cannot know the exactly feasible expected return region before the resampling process. Finally it does not have a sound theoretical foundation and one can just use it like a “black box” without bringing in the prior judgment about the data sample used and uncertainty from the future.

### SUMMARY OF THE INVENTION

So, from a perspective of a graph theory, this invention is totally a different method to realize the robust portfolio selecting optimization. In the framework of original mean-variance method, constructing a portfolio is actually a process of scalar-weighted for return and vector-weighted for variance. Under the normal assumptions and short selling restriction, remodeling the analysis into an orthogonal coordinate system, all portfolios' coordinates are in a convex hull, and their weighted operation is closed. What's more, the coordinates of portfolios with the same return are also in a convex hull, with their weighted operation closed. Based on the geometrical point of view, one can get the “conditional centroid” by averaging the boundary points portfolios from the convex hull with the same given return. And similarly, one can also get the “unconditional centroid” for entire convex hull. It turns out to be the naive portfolio, namely the portfolio with the same weights for all assets.

These two kinds of “centroid portfolios” have significant anti-noise property. This invention is based on the stability of geometric centroid, using two compromises to realize the robust optimization. The compromise between original mean-variance optimal portfolio and “conditional centroid” embodies confidence for risk region. And the compromise with “unconditional centroid” is for the uncertainty about the future from the historical sample. The method has the steps of:

a. computing average normal returns of input data and ascending the assets order by results. Then compute the corresponding covariance matrix Σ.
b. in accordance with the highest and lowest average returns, R_{MAX} and R_{MIN}, set return feasible region belonging to (R_{MAX}, R_{MIN}). Then based on the requirement for accuracy, set the step to discrete the return feasible region to get the discrete return set.
c. for each return point, R*, constructing the corresponding boundary points portfolios from its convex hull: First, constructing auxiliary portfolios by the flowing step: 1. based on the result of ascend, dividing the plurality of assets into high return group, low return group and equal return group. 2. transforming the assets of all groups into portfolios weights with zero for other assets. 3. selecting a portfolio from each high return group and low return group with no repeat, and based on these two, constructing a new portfolio subjected to that return equals R*. 4. combining these new portfolios together with equal return group and so will get the auxiliary portfolios set. If not under a completed multi-collinearity case, constructed auxiliary portfolios set is the boundary points portfolios set of the corresponding convex hull. If unfortunately enough, auxiliary portfolios set will have some internal points that one can also compute the approximate centroid or use high-dimensional convex hull algorithm find the real boundary points portfolios set for accuracy.

Then compute conditional centroid of R* by the auxiliary portfolios set and ordinal mean-variance efficient frontier portfolio and compute modified weighted efficient frontier portfolio by the following method

w_{PO}=τ((1−α)w_{MV}+αw_{CG})+(1−τ)w_{UG}

Where row vectors w_{PO}, w_{MV}, w_{CG} and w_{UG} are weighted efficient frontier portfolio weight, mean-variance efficient frontier portfolio weight, conditional centroid weight and unconditional centroid (equal weight). τ and α are sample reliability and confidence level. These two parameters are in the range of [0,1]. After the two compromises, the final real weighted efficient frontier return R_{PO} and variance V_{PO} are:

R_{PO}=τR*+(1−τ)R_{UG}

V_{PO}=w_{PO}Σ⁻¹w_{PO}^{T}

where R_{UG} is the return of unconditional centroid, namely the portfolio with the equal weight.
g. selecting a portfolio by original mean-variance utility function or return/risk objective based on the new weighted frontier.

What's more important, two parameters, α and τ, can be also constant or certain functions of return points from return set. In fact, if unconditional centroid portfolio return R_{UG} is already calculated, one can figure out the return range after this modification, which belongs to ((1−τ) R_{UG}+τ R_{MIN}, (1−τ) R_{UG}+τ R_{MAX}).

And also the return level before modification is as followed:

$${R}^{*} = \frac{{R}_{PO} - ( 1 - τ ) {R}_{UG}}{τ}$$

It can be used for just desired return objectives.

### BRIEF DESCRIPTION OF THE DRAWINGS

FIG. 1 METHOD FLOWCHART

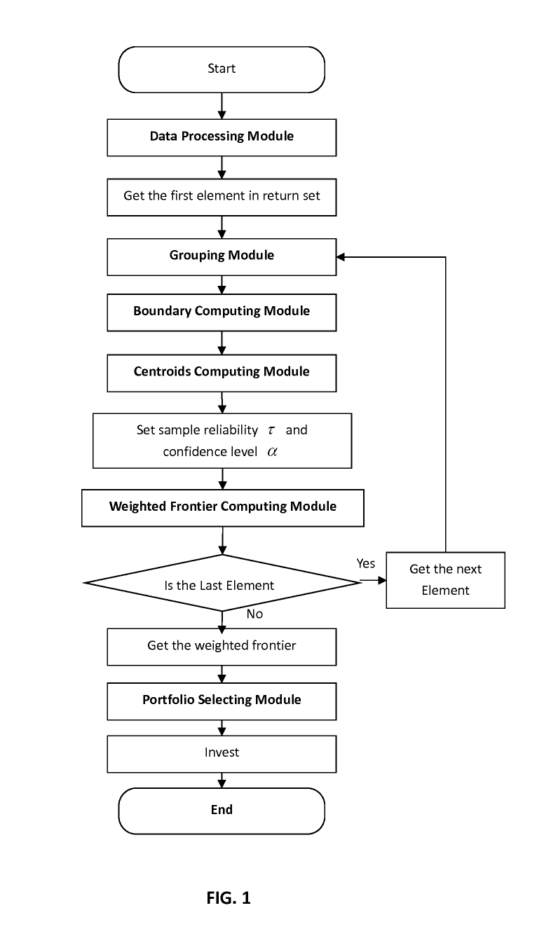

FIG. 2 DATA PROCESSING MODULE FLOWCHART

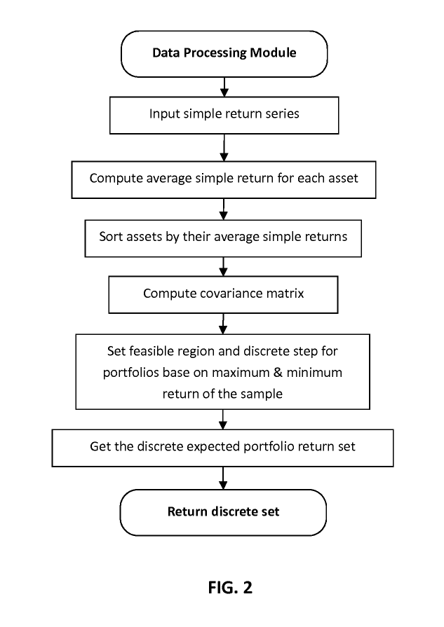

FIG. 3 GROUPING MODULE FLOWCHART

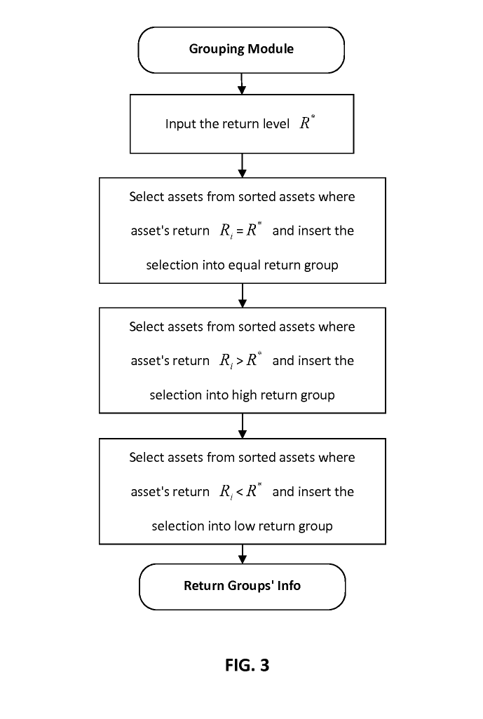

FIG. 4 BOUNDARY COMPUTING MODULE FLOWCHART

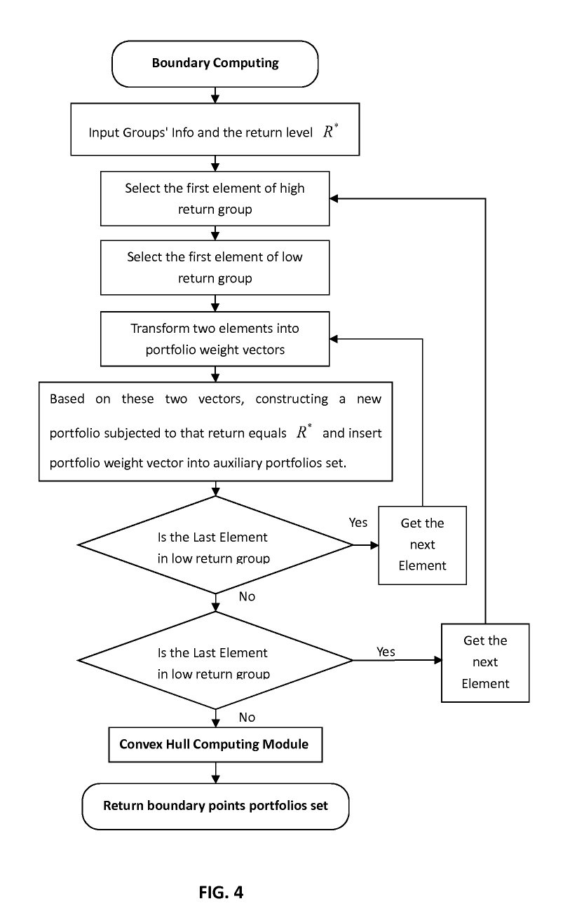

FIG. 5 CONVEX-HULL COMPUTING MODULE FLOWCHART

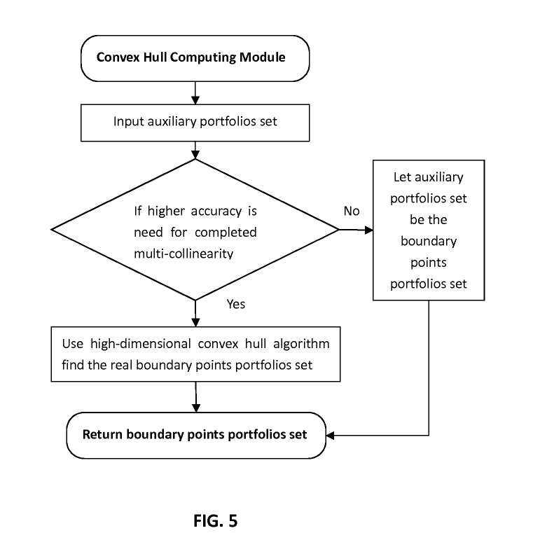

FIG. 6 CENTROIDS COMPUTING MODULE FLOWCHART

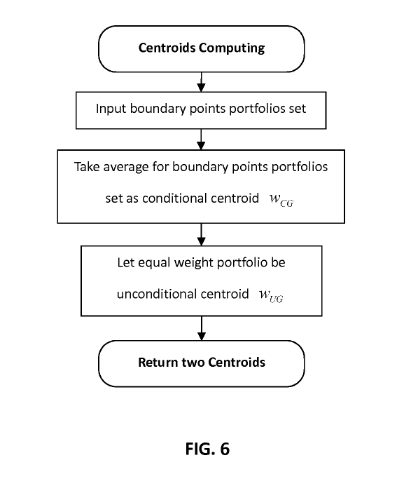

FIG. 7 WEIGHTED FRONTIER COMPUTING MODULE FLOWCHART

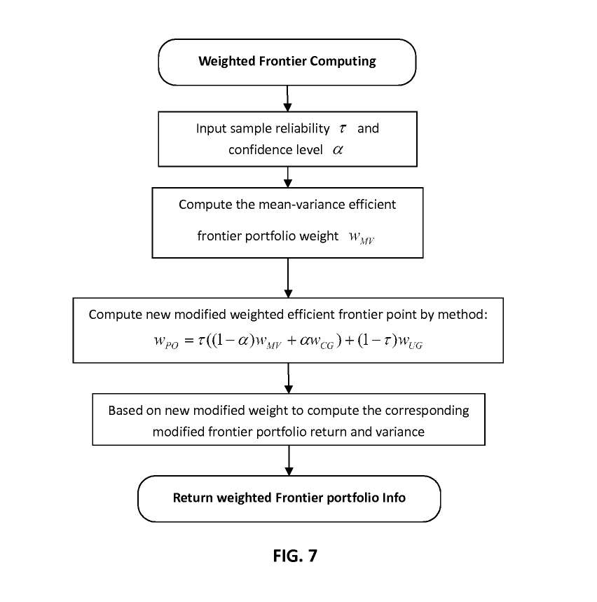

FIG. 8 PORTFOLIO SELECTING MODULE FLOWCHART

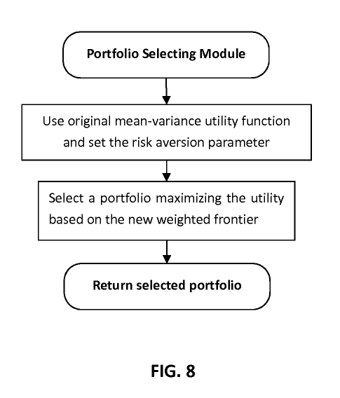

### DETAILED DESCRIPTION OF PREFERRED EMBODIMENTS

it is recognized that MV optimization is a statistical procedure, based on estimated returns subject to a statistical variance, and that, consequently, the MV efficient frontier, as defined above, is itself characterized by a variance. Instead of resampling methods, this method is based on the stability of geometric centroid to reduce the variance of the optimized results significantly. This kind of variance reduction technique based on centroid portfolio methods are within the scope of the invention as described herein, and as claimed in any appended claims.

In an alternative embodiment, the disclosed method for evaluating an existing or putative portfolio may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hard-ware. Still other embodiments of the invention are implemented as entirely hardware, or entirely software (e.g., a computer program product).

The described embodiments of the invention are intended to be merely exemplary and numerous variations and modifications will be apparent to those skilled in the art. All such variations and modifications are intended to be within the scope of the present invention as defined in the appended claims.

What is claimed is:

1. A method for selecting a value of portfolio weight for each of a plurality of assets of an optimal portfolio, the value of portfolio weight chosen from values between zero and unity, each asset having a defined expected return and a defined variance or standard deviation of return, each asset having a covariance with respect to each of every other asset of the plurality of assets, the method comprising:
a. computing a mean-variance efficient frontier based at least on input data characterizing the defined expected return and the defined standard deviation of return of each of the plurality of assets;
b. constructing auxiliary portfolios with same return based on the result of sort;
c. using simple or other high-dimensional convex hull algorithm to figure out boundary points portfolios set;
d. computing corresponding conditional centroids based on boundary points portfolios set;
e. computing a weighted efficient portfolio frontier with unconditional centroid and conditional centroids with property sample reliability and confidence level;
f. selecting a portfolio weight for each asset from the weighted efficient frontier according to a specified utility function or return/risk objective;
g. investing funds in accordance with the selected portfolio weights.

2. A method for investing funds based on an evaluation of an existing portfolio having a plurality of assets, the existing portfolio having a total portfolio value, each asset having a value forming a fraction of the total portfolio value, each asset having a defined expected return and a defined variance or standard deviation of return, each asset having a covariance with respect to each of every other asset of the plurality of assets, the method comprising:
a. computing a mean-variance efficient frontier based at least on input data characterizing the defined expected return and the defined variance or standard deviation of return of each of the plurality of assets;
b. constructing auxiliary portfolios with same return based on the result of sort;
c. using simple or other high-dimensional convex hull algorithm to figure out boundary points portfolios set;
d. computing corresponding conditional centroids based on boundary points portfolios set;
e. computing a weighted efficient portfolio frontier with unconditional centroid and conditional centroids with property sample reliability and confidence level;
f. selecting a portfolio weight for each asset from the weighted efficient frontier according to a specified utility function or return/risk objective;
g. investing funds in accordance with the selected portfolio weights.

3. A method for investing funds based on evaluation of an existing portfolio having a plurality of assets, the existing portfolio having a total portfolio value, each asset having a value forming a fraction of the total portfolio value, each asset having a defined expected return and a defined variance or standard deviation of return, each asset having a covariance with respect to each of every other asset of the plurality of assets, the method comprising:
a. computing a mean-variance efficient frontier based at least on input data characterizing the defined expected return and the defined standard deviation of return of each of the plurality of assets;
b. constructing auxiliary portfolios with same return based on the result of sort;
c. using simple or other high-dimensional convex hull algorithm to figure out boundary points portfolios set;
d. computing corresponding conditional centroids based on boundary points portfolios set;
e. computing a weighted efficient portfolio frontier with unconditional centroid and conditional centroids with property sample reliability and confidence level;
f. selecting a portfolio weight for each asset from the weighted efficient frontier according to a specified utility function or return/risk objective;
g. investing funds in accordance with the selected portfolio weights.

4. A computer program product for use on a computer system for selecting a value of portfolio Weight for each of a specified plurality of assets of an optimal portfolio and for enabling investment of funds in the specified plurality of assets, the value of portfolio Weight chosen from values between zero and unity, each asset having a defined expected return and a defined variance or standard deviation of return, each asset having a covariance with respect to each of every other asset of the plurality of assets, the computer program product comprising a computer usable medium having computer readable program code thereon, the computer readable program code including:
a. program code for causing a computer to perform the step of computing a mean-variance efficient frontier based at least on input data characterizing the defined expected return and the defined variance or standard deviation of return of each of the plurality of assets;
b. program code for causing a computer to perform the step of constructing auxiliary portfolios with same return based on the result of sort;
c. program code for causing a computer to perform the step of using simple or other high-dimensional convex hull algorithm to figure out boundary points portfolios set;
d. program code for causing a computer to perform the step of computing corresponding conditional centroids based on boundary points portfolios set;
e. program code for causing a computer to perform the step of computing a weighted efficient portfolio frontier with unconditional centroid and conditional centroids with property sample reliability and confidence level;
f. program code for causing a computer to perform the step of selecting a portfolio weight for each asset from the weighted efficient frontier according to a specified utility function or return/risk objective.

5. A method for managing a portfolio, said portfolio consisting of a plurality of assets, the method comprising:
(a) collecting a defined expected return, a defined variance or standard deviation of return of each asset;
(b) collecting a covariance between each other of assets;
(c) calculating a mean-variance efficient frontier based on the defined expected return and the defined standard deviation of return of each asset;
(d) creating an auxiliary set of assets;
(e) determining boundary set by using simple or other high-dimensional convex hull algorithm;
(f) calculating conditional centroids based on the boundary set;
(g) calculating a weighted efficient portfolio frontier with unconditional centroid and the conditional centroid;
(h) selecting a weighted value for each asset base on the weighted efficient frontier and a specified utility function or return/risk objective;
(i) generating an evaluation for the portfolio or/and allocating assets within the portfolio based on the weighted values of assets.

6. The method for managing a portfolio according claim 5, wherein said auxiliary set of assets is created by sorting assets from each high return and low return.

7. The method for managing a portfolio according claim 5, wherein the weighted efficient portfolio frontier for each asset is calculated by an equation depicted as
w_{PO}=τ((1−α)w_{MV}+αw_{CG})+(1−τ)w_{UG},
wherein w_{PO}=the weighted efficient portfolio frontier, α=confidence level, τ=sample reliability, w_{MV}=mean-variance weighted efficient portfolio frontier, w_{CG}=conditional centroid and w_{UG}=unconditional centroid.

8. The method for managing a portfolio according claim 5, wherein the asset is selected from the group consisting of mutual fund, closed end fund, exchange traded fund, hedge fund, trust fund, venture capital fund, fund, of funds, money market fund, convertible security, derivative, loan, debenture, certificate of deposit, commodity, future, option, tax exempt security, stock, bond, swap and real estate.
